(19) United States
(12) Patent Application Publication
(10) Pub. No.: US 2025/0069154 A1
(43) Pub. Date: Feb. 27, 2025

(54) SYSTEM AND METHOD FOR IMPLEMENTING A RESEARCH AND DEVELOPMENT TAX CREDIT RISK TRACKER TOOL

(71) Applicant: KPMG LLP, New York, NY (US)

(72) Inventors: Ajay Wanchoo, Bernardsville, NJ (US); Gregory A. Bocchino, Wilton, CT (US)

(21) Appl. No.: 18/812,530

(22) Filed: Aug. 22, 2024

Related U.S. Application Data
(60) Provisional application No. 63/533,958, filed on Aug. 22, 2023.

(51) Int. Cl. G06Q 40/10; G06Q 10/0635

(52) U.S. Cl. CPC G06Q 40/10; G06Q 10/0635

(57) ABSTRACT

An embodiment of the present invention is directed to a Research and Development (R&D) Risk Assessment and Optimization Tool that identifies risk tolerance and business component coverage based on changes in various factors including headcount, Qualified Research Expenditures (QRE), project management count, title changes, team changes, etc. The changes may be based on a time period, such as year-to-year changes.

### CROSS-REFERENCE TO RELATED APPLICATIONS

The application claims priority to U.S. Provisional Application 63/533,958 (Attorney Docket No. 055089.0000116), filed Aug. 22, 2023, the contents of which are incorporated by reference herein in their entirety.

### FIELD OF THE INVENTION

The present invention relates to systems and methods for implementing a research and development (R&D) tax credit risk assessment and optimization tool.

### BACKGROUND

Entities operating across various industries may benefit from research and development (R&D) tax credits per Internal Revenue Code Section 41. For example, if an entity invests in qualified research activities, a tax credit may be available. Qualified research activities may include internal software solutions and applications as well as various technology advancements. To claim the tax credit, an entity will perform a study that involves identifying, documenting and supporting eligible expenses associated with qualified R&D activities. A thorough R&D analysis and gathering of supporting documentation is therefore needed to properly claim the R&D credits.

The eligibility and documentation requirements are extensive and complex. In addition, there are penalties for improper filings. Claiming the R&D tax credit with improper supporting evidence is risky and costly. The current process is burdensome and manual in nature without clear guidance on a common acceptable form or template.

Modern software development delivery involves lean practices with no formal tracking of engineering personnel and lack of technical documentation. These lean processes are not designed to support the requirements for conducting Section 41 R&D studies and thereby create significant inefficiencies.

With an organization's size and available resources, it may not be practical or even possible to conduct interviews and amass extensive supporting documentation and data to support certain credit claims and incentives. Some entities may want to limit resources in the form of the number of interviews, (e.g., no more than 50 interviews), efforts to document business components (e.g., limit documentation efforts to 50 business components), etc. An entity may take an aggressive position which may result in a minimal number of interviews. As a result, coverage may drop accordingly.

It would be desirable, therefore, to have a system and method that could overcome the foregoing disadvantages of known systems.

### SUMMARY

According to an embodiment, the invention relates to a computer-implemented system that implements a research and development (R&D) risk assessment and optimization tool. The system comprises: an interface that is configured to access one or more data sources and display risk optimization data; a memory component that stores and manages data relating to research and development assessment; and a computer processor coupled to the interface and the memory component, the computer processor further configured to: identify, via the computer processor, one or more datasets relevant to a research and development tax credit for an entity; extract, via the interface, data from the one or more data sources, wherein the data comprises project data and human resource data related to one or more business components; analyze; via the computer processor, the human resource data to identify employee movement data that represents headcount change, title change and team change; analyze; via the computer processor, the project data to identify variances for the one or more datasets for each business component associated with an entity, wherein the variances relate to the headcount change, the title change, the team change, an activity change and a Qualified Research Expenditures (QRE) change; assess, via the computer processor, risk profiles based on the variances for the one or more datasets by business component; identify, via the computer processor, a ranked set of business components based on the variances for the one or more datasets; based on the ranked set of business components, generate a risk optimization model through a machine learning algorithm that learns from prior engagements and dynamically determines weights for a set of risk variance parameters comprising: requirements, risk tolerances, reserve, and business component coverage; automatically optimize risk, via the computer processor, based on a combination of the set of risk variance parameters; and provide, via the interface, the optimized risk and one or more graphics representing the requirements, the risk tolerances, the reserve, and the business component coverage.

According to another embodiment, the invention relates to a computer-implemented method that implements a research and development (R&D) risk assessment and optimization tool. The method comprises the steps of: identifying, via a computer processor, one or more datasets relevant to a research and development tax credit for an entity; extracting, via an interface, data from one or more data sources, wherein the data comprises project data and human resource data related to one or more business components; analyzing; via the computer processor, the human resource data to identify employee movement data that represents headcount change, title change and team change; analyzing; via the computer processor, the project data to identify variances for the one or more datasets for each business component associated with an entity, wherein the variances relate to the headcount change, the title change, the team change, an activity change and a Qualified Research Expenditures (QRE) change; assessing, via the computer processor, risk profiles based on the variances for the one or more datasets by business component; identifying, via the computer processor, a ranked set of business components based on the variances for the one or more datasets; based on the ranked set of business components, generating a risk optimization model through a machine learning algorithm that learns from prior engagements and dynamically determines weights for a set of risk variance parameters comprising: requirements, risk tolerances, reserve and business component coverage; automatically optimizing risk, via the computer processor, based on a combination of the set of risk variance parameters; and providing, via the interface, the optimized risk and one or more graphics representing the requirements, the risk tolerances, the reserve, and the business component coverage.

An embodiment of the present invention is directed to an innovative risk assessment and optimization tool that achieves an optimal balance between risk exposure (e.g., risk defined by a set of dimensions) and how much coverage is adequate based on effort and impact to an organization. Effort may include time and/or resources to obtain proper documentation/data, conduct interviews with subject matter experts (SMEs), prepare write-ups/narratives that support the claim and/or other actions. Risk may be tied to a “reserve” which may include allocated funds, an amount owed, liabilities, etc. Generally, an entity will want to use as little reserve as possible. According to an embodiment of the present invention, the reserve may be balanced with risk, e.g., not taking on more risk than an entity is able to support when making a credit claim. The entity may need to provide upfront effort (e.g., time, resources, etc.) to support a credit claim or other incentive. An embodiment of the present invention may identify a level of resources to support the credit claim while considering the amount of risk exposure an entity is willing to take.

An embodiment of the present invention is directed to identifying risk tolerance and business component coverage based on variances in a set of parameters including headcount, expenditures, project management activity, title changes, team changes, etc. Current processes focus only on expenses without understanding team variances and quality of activities. An embodiment of the present invention provides a multi-dimensional approach that uncovers efficiencies and opportunities that are not possible with current systems and methodologies. Technical benefits include improved data analysis, risk assessments and insights, an enhanced understanding of opportunities as well as a substantial reduction of time and resources in managing risk and efforts in performing R&D credit assessment.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary illustration of employee movement, according to an embodiment of the present invention.

FIG. 2 is an exemplary illustration of a risk profile, according to an embodiment of the present invention.

FIG. 3 is an exemplary illustration of a risk profile, according to an embodiment of the present invention.

FIG. 4 is an exemplary illustration of risk optimization, according to an embodiment of the present invention.

FIG. 5 illustrates an exemplary dashboard, according to an embodiment of the present invention.

FIG. 6 illustrates an exemplary dashboard, according to an embodiment of the present invention.

FIG. 7 is an exemplary system diagram, according to an embodiment of the present invention.

FIG. 8 is an exemplary flowchart, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to a Research and Development (R&D) Risk Assessment and Optimization Tool that identifies and optimally balances risk tolerance and business component coverage based on changes in various factors including headcount, Qualified Research Expenditures (QRE), project management count (e.g., JIRA Count), activity, title changes, team changes, etc. The changes may be based on a time period, such as year-to-year changes. Current systems, at most, offer a limited view based on a single dimension without an ability to optimally and intelligently balance risk and coverage based on business components. An embodiment of the present invention provides flexibility, efficiencies and optimization of resources and technology that are not available with current systems.

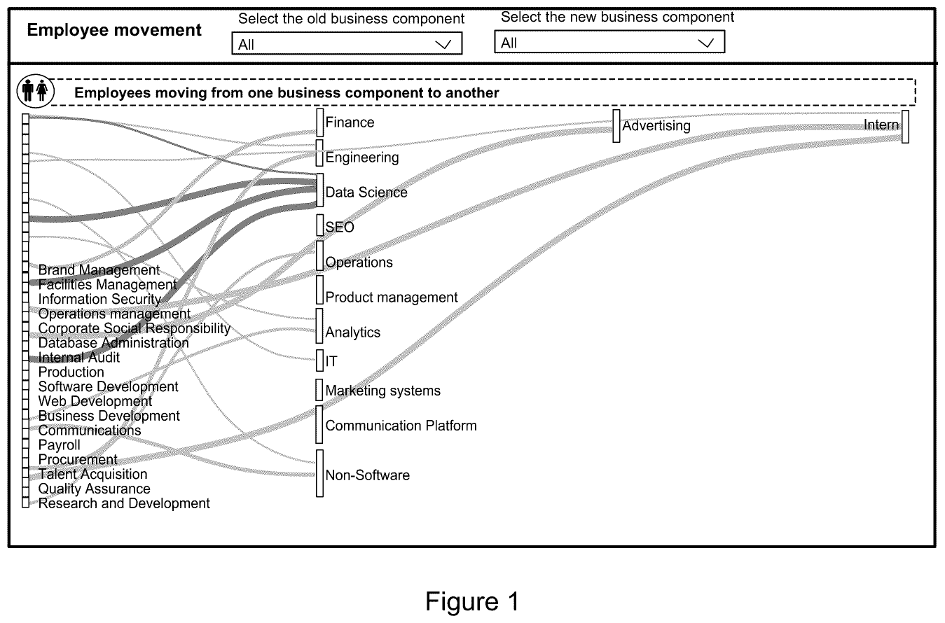

FIG. 1 is an exemplary illustration of employee movement, according to an embodiment of the present invention. FIG. 1 provides a comprehensive overview of the count of employees moving from one business component to another. FIG. 1 represents one example of a visual representation. Other visual representations may be applied. Data may be provided from various sources including internal databases, workflows (e.g., Alteryx generated workflows), internal/external sources, etc.

For example, a user may select an old business component and a new business component from drop-down boxes as shown in the interface of FIG. 1. The interface may then display a number of employees who moved from the former to the latter business component. FIG. 1 provides an exemplary illustration in the form of a graphic. In this illustration, the business components depicted in the chart represent a higher degree of employee movement among departments. Departments with low employee movement may not be shown due to space constraints.

From this visualization, an embodiment of the present invention provides insights, such as employees who move from a ‘Qualified’ business component to a ‘Non-Qualified’ business component may need not be interviewed. Additionally, the breadth of the links in the illustration of FIG. 1 may be directly proportional to the count of the employees who moved. Other metrics may be captured and displayed.

For example, a user may select ‘Payroll’ as the old business component, and ‘Non-Software’ as the new business component. In this example, the corresponding visual may indicate that nine employees moved from the former to the latter business component.

FIG. 1 illustrates exemplary business components including brand management, facilities management, information security, information technology (“IT”), operations management, systems administration, corporate social responsibility, database administration, internal audit, production, software development, web development, business development, communications, payroll, procurement, talent acquisition, quality assurance, research and development. Other business components may include: Finance, Engineering, Data Science, SEO (search engine optimization), Operations, Product Management, Analytics, IT, Marketing Systems, Communication Platform, and Non-Software. Additional employee movement may be shown by Advertising and Intern in FIG. 1.

As shown in FIG. 1, an embodiment of the present invention is directed to analyzing team change details, e.g., team size, movement, titles, promotions, transitions, responsibilities, duties, etc. For example, a team may have the same number of employees from last year, but a number of members may have new titles, job responsibilities, etc. Reorganizations may also affect risk and an ability to properly claim tax credit, benefits and incentives. While the number of team members may be the same, there may be a high amount of movement between various teams that may lead to additional risks and justify a need to conduct interviews.

For example, a larger team may be eligible for a higher credit which may lead to a higher risk while a small team with a small impact may have a low risk. Accordingly, if enough interviews are not conducted for a larger team, this may increase the risk even higher. In another example, a team may have members with multiple title changes from year-to-year, but the headcount may remain substantially the same. This situation may indicate an increased potential for responsibility changes. For example, an individual contributor with a previous significant research workload may now have transitioned to a manager with more supervisory tasks and less research. As a result, the risk may increase for this team. Other factors to consider may include activity captured by a system that tracks certain actions, such as an issue tracking system (e.g., JIRA); software development system that records activity; etc.

An embodiment of the present invention may be applied to Qualified Research Expenses (QREs). An embodiment of the present invention may examine how much is being claimed due to wages or other business components to support a credit claim. For example, more resources (e.g., funds, etc.) that are being claimed, more efforts may be needed.

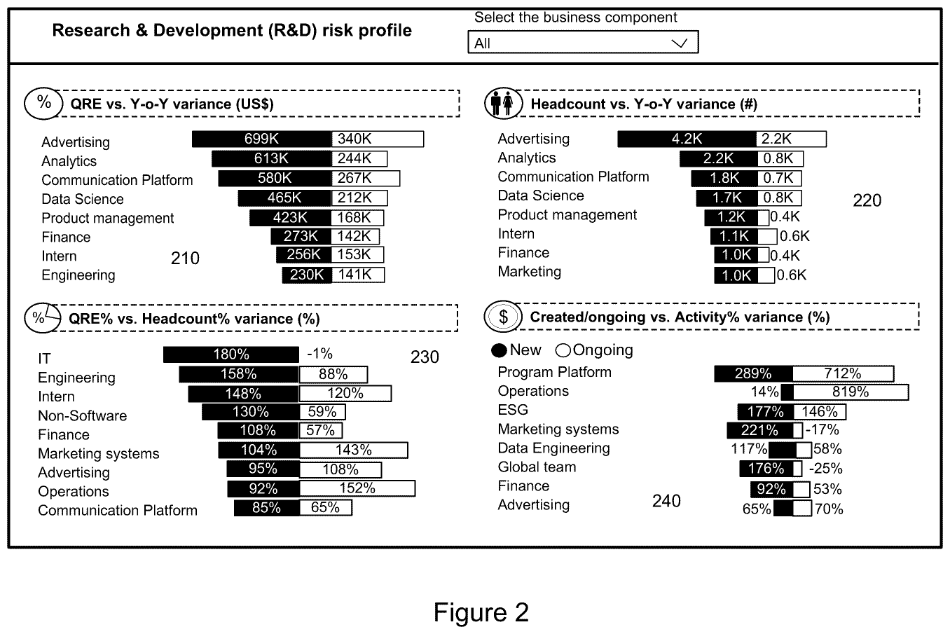

FIG. 2 is an exemplary illustration of a risk profile, according to an embodiment of the present invention. In this example, a Risk Profile may depict changes (e.g., year-over-year changes) in various datasets used to calculate the Research and Development (R&D) tax credits, in the form of illustrative charts. In this example, the illustrations are shown as tornado charts but other graphics may be supported. While an embodiment of the present invention is directed to R&D Tax Credit, other incentives and credits may be supported. Incentives and credits may be specific for type of work, industry, geography, etc.

An embodiment of the present invention may receive inputs from various sources. Data may include: (Headcount (HC) Variance (Var), HC Var %, QRE Var, QRE Var %, Activity Var, Activity Var %; Variance, Variance %); (Business component, Current Year (CY) HC, Previous Year (PY) HC, CY QRE, PY QRE, CY Activity, PY Activity; Business component, Ongoing/New, CY Value, PY Value); data from workflows; etc.

As shown in FIG. 2, for a business component, various parameters may be illustrated. Parameters may include QRE vs. Y—O—Y variance 210; Headcount vs. Y—O—Y variance 220; QRE % vs. Headcount % variance 230 and Created/ongoing vs. Activity % variance 240.

QRE vs. Y—O—Y variance 210 shows an increase/decrease in the Qualified Research Expense (QRE) figures between the current year and the previous year, sorted in descending order by business components. Here, the variance is shown in US dollars.

Headcount vs. Y—O—Y variance 220 depicts an increase/decrease in the headcount values between the current year and the previous year, sorted in descending order by business components.

QRE % vs. Headcount % variance 230 highlights the QRE and Headcount variations of the business component as percentages, with the QRE and headcount percentages. This variance may represent headcount change and shift in spending year-to-year.

Created/ongoing vs. Activity % variance 240 showcases the variations in the business component, with respect to both ‘Ongoing’ and ‘New’ activities, as percentages by business components. Other factors to consider may include project/team funds and spend. Level of development activity may be captured and analyzed as well.

An embodiment of the present invention enables users to isolate team change and access additional insights associated with team movement and other activity. For example, a large change in QRE dollar amount with a small change in headcount on a year-to-year basis may indicate a significant increase in activity. This may signify an increase in risk given the amount of activity with respect to low change in headcount. In another instance, changes that are commensurate with variances in a team or business component may seem normal and therefore not affect or increase risk. In yet another example, a team with significant increase in headcount may indicate a change in focus (e.g., shift from website development to AI/ML development) and thereby support an increase in risk.

An embodiment of the present invention may use risk assessment to prioritize certain requirements. For example, a business may restrict the number of interviews or other resources and efforts. An embodiment of the present invention may then analyze risk level and prioritize the interviews, e.g., top 10 interviews. Other resources may be considered and conserved.

In addition to team changes, other factors may be analyzed for risk. Such factors may include: how much money is involved (e.g., how much was spent on a business component); variances in spend (e.g., spend for current year increased by 70% which may indicate a shift in activity or focus); use of AI (e.g., use of AI models may lead to more cloud resources and associated expenses that may be eligible for a credit claim); etc.

For example, an entity may have a first business component with $10M spend and 100 members. A second business component may have $5M spend with 200 members. The first business component may include more senior members (e.g., highly compensated members with higher skillsets). Generally, senior members spend minimal time on research and instead focusing on strategy (which would not qualify for credit). An embodiment of the present invention is directed to analyzing activity data. In this example, a senior member may actually have significant development activity. The activity may include coding activity as supported by issue tracking system that indicates a significant lines of coding checked in by the senior member. Accordingly, an embodiment of the present invention is able to support potential credit claims and/or other qualifying incentives with development activity data.

An embodiment of the present invention may be directed to identifying potential risk areas and then determining an appropriate amount of effort and resources to spend to support a credit claim, incentive and/or other action.

An embodiment of the present invention may leverage artificial intelligence (AI)/machine learning (ML) to learn from prior engagements and dynamically determine weights for various team changes and/or other factors. The weights may be trained using ML through prior engagements as well as other data and metrics.

An embodiment of the present invention may facilitate interviews through an AI model. For example, an interview script may be generated to facilitate the interview process. An embodiment of the present invention may generate follow-up questions and/or action items, generate a compelling narrative, determine risk and find areas to mitigate risk (e.g., additional documentation, evidence, etc.). Depending on the scenario, AI assisted processes may increase the risk and affect cost (e.g., reduce resources; increase cloud storage costs, etc.).

According to an embodiment of the present invention, interviews may be further divided into categories: human conducted interviews with business components; AI assisted interviews; and no interviews (e.g., cost prohibitive).

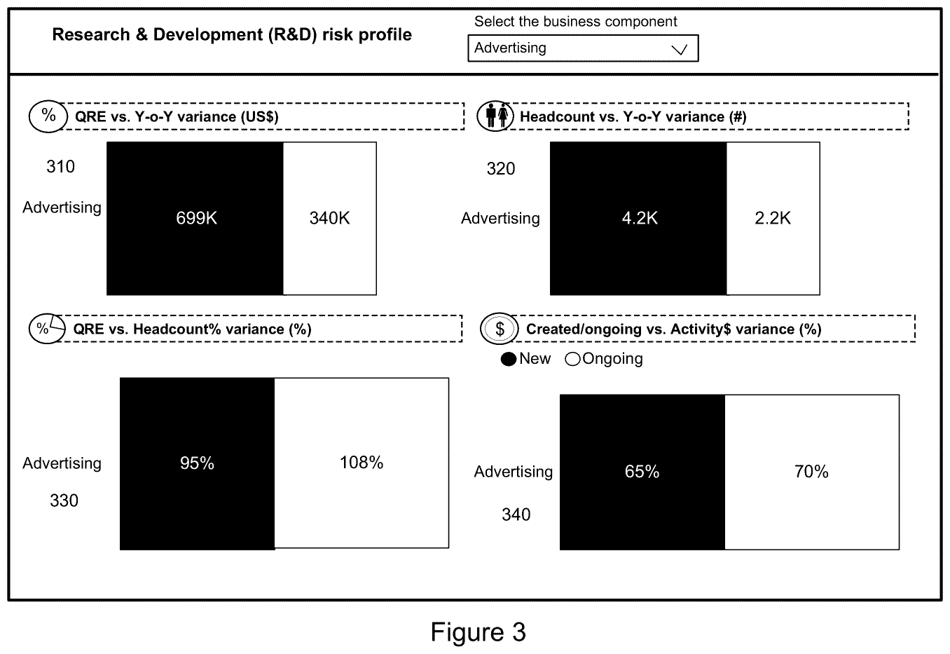

FIG. 3 is an exemplary illustration of a risk profile, according to an embodiment of the present invention. According to an embodiment of the present invention, a user may select a business component, such as “Advertising”, from a drop-down box and view various values visually represented in the graphs. Other graphics, illustrations and user interactive components may be supported.

Section 310 shows QRE vs. Y—O—Y variance (US$): Current year QRE (US$699,372) and QRE Variance (US$339,967).

Section 320 shows Headcount vs. Y—O—Y variance: Current year headcount (4,167) and Headcount Variance (2,167).

Section 330 shows QRE % vs. Headcount % variance: QRE variance % (94.6%) and Headcount Variance % (108.3%).

Section 340 shows Created/ongoing vs. Activity % variance: New variance % (65%) and Ongoing variance % (70.5%).

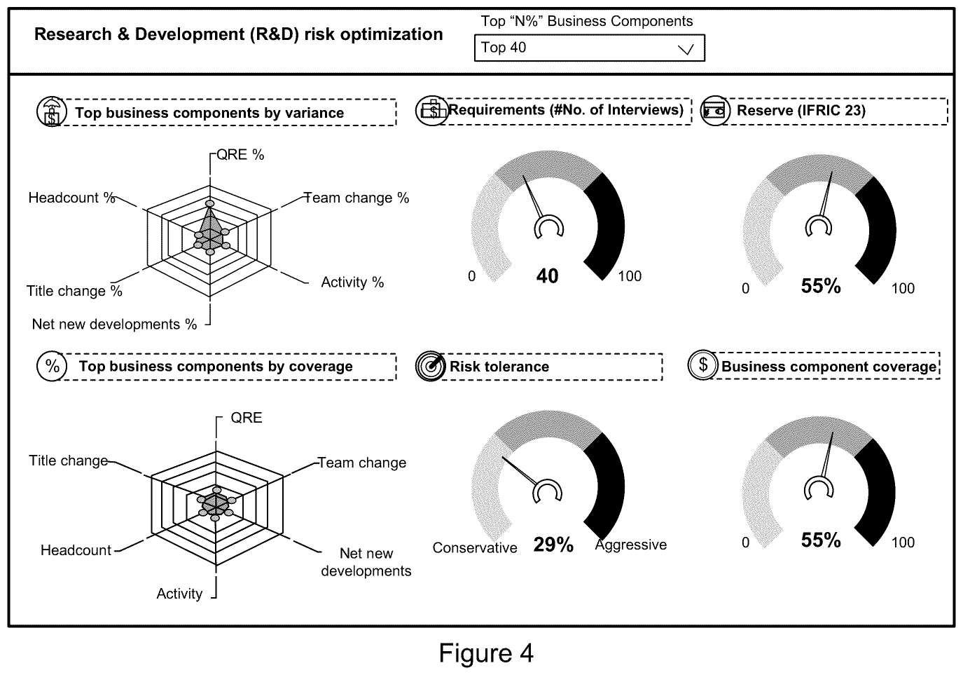

FIG. 4 is an exemplary illustration of risk optimization, according to an embodiment of the present invention. FIG. 4 illustrates a Risk Optimization interface that provides a visual representation of the appropriate risk tolerance percent and reserve percent based on the changes factoring the business components.

The Risk Optimization interface may include various interactive charts and illustrations. For example, FIG. 4 illustrates two radar charts and four-gauge charts. Other graphics and different number of charts/graphics may be supported. An embodiment of the present invention may receive inputs from various sources. Data may include: Rank, Business components, Radar tangents, Number of interviews, Risk tolerance, Maximum interviews, Maximum risk tolerance, Number of follow-ups, Reserve, QRE coverage, BC coverage; etc.

For any given business component, the Risk Optimization interface may exhibit various parameters, such as Top business components by variance (percentages %); Top business components by coverage; Requirements (e.g., number of interviews); Risk tolerance (percentages %); Reserve (IFRIC 23); Business component coverage (percentages %); etc.

As shown in FIG. 4, Risk Optimization interface provides analysis and insights. Once the “Top N %” value is determined, the user gains an understanding about the required number of interviews, the risk tolerance involved, and all the variation and coverage figures with regards to the top business components. The dashboard also indicates whether the figures in the gauge charts are conservative or aggressive. The “Top business components by variance” radar chart indicates variations (in this example, yearly variations) for the parameters as percentages, while the “Top business components by coverage” radar chart highlights the coverage percentages of that parameter across the Top N % of business components.

For example, “Top business components by variance” illustrates coverage that is currently available. By adjusting “Top N % business components,” the coverage may update accordingly. By considering the factors, such as Headcount, Title Change, Net new developments, Activity, Team Change and QRE, an entity may view adjustments and focus on obtaining an optimal amount of coverage.

For example, “Top business components by coverage” illustrates factors including Title Change, Headcount, Activity, Net new developments, Team Change and QRE. For certain products, a large number of new features may have been developed. This may include new features, products, software, algorithms, etc. FIG. 4 further illustrates details relating to Requirements, Risk Tolerance, Reserve, and Business component coverage. By adjusting one factor, the other factors may be automatically adjusted in response.

Top business components may include: Top 20 qualified research expenses; Top 10 by dollar amount, etc. Other dimensions may be applied. Each business component may have a certain amount of associated funds, number of people, new business activity, etc.

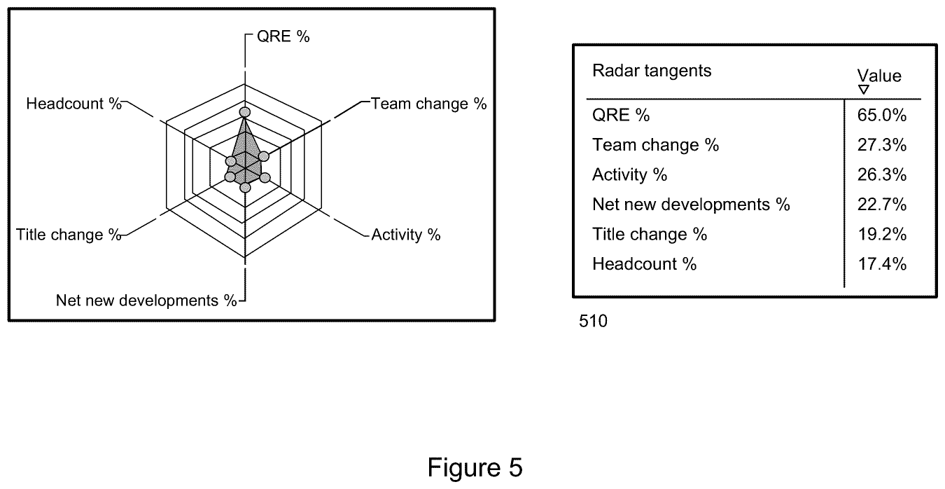

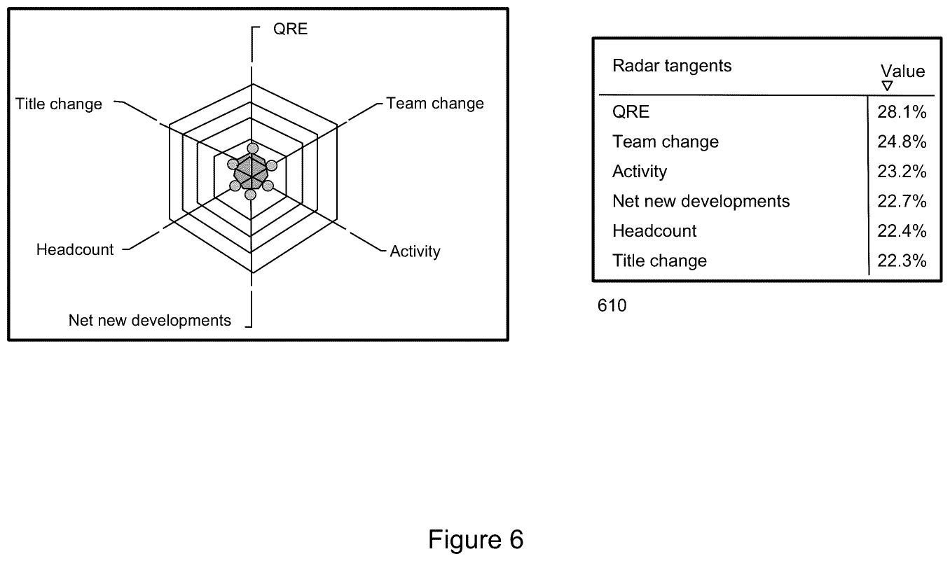

For example, a user may select a specific “Top N %” value from the drop-down box. In this example, the user may select “Top 40.” At the top of the “Risk Optimization” tab, an embodiment of the present invention may provide dashboards, as shown by FIGS. 5 and 6.

FIG. 5 illustrates an exemplary dashboard, according to an embodiment of the present invention. Section 510 illustrates a top business components by variance Radar chart-QRE variation % (65%), Team change % (27.3%), Activity % (26.3%), Net new developments % (22.7%), Title change % (19.2%), Headcount % (17.4%)

FIG. 6 illustrates an exemplary dashboard, according to an embodiment of the present invention. Section 610 illustrates a top business components by coverage-QRE (28.1%), Team change (24.8%), Activity (23.2%), Net new developments (22.7%), Headcount (22.4%), Title change (22.3%)

Additional details may include: Number of interviews required—30; Risk tolerance—24%; Reserve (IFRIC 23)—59%; and Business component coverage—30%.

An embodiment of the present invention is directed to an adaptive estimated workplan which may include an estimation worksheet, timeline worksheet as well as other details. A user may change various parameters to balance risk and effort. For example, a user may modify number of interviews, number of documents, effort involved, etc. The adjustment of parameters may then drive the timeline which may detail effort and resources. An embodiment of the present invention may be directed to an actionable dashboard with a prediction feature relating to human resources, timing, constraints, etc.

An embodiment of the present invention may extract data from client documentation stored and managed in repositories, document management tools, project management systems, etc. An embodiment of the present invention may access various repositories, track software development and other activity (e.g., what features are being built, what software is being written, etc.), and gather metadata and corresponding content. The extracted data may be processed through statistical analysis to accurately identify a level of activity by each participant, estimated time of investment and/or other metrics on a project, matter or user basis. For example, this may involve analyzing the number of entries, lines of code and/or other activity performed.

An embodiment of the present invention may ingest raw activity data from an internal activity tracking system (e.g., JIRA, Asana, GitHub, Trello, etc.).

An embodiment of the present invention may identify subject matter experts (SMEs), direct support R&D employees and other participants in projects.

The risk tracker tool may be customized to support various applications, use cases and industries. An embodiment of the present invention further provides real-time visualization of key insights through custom dashboards and/or other interfaces.

An embodiment of the present invention provides relevant technical document identification and classification per Section 41 four-part test. An exemplary multi-part test may include a general four-part test applied as detailed in section 41(d) and Treas. Reg. § 1.41-4 (a). In this example, “qualified research” activities must satisfy the following requirements of a four-part test: (1) Permitted Purpose; (2) Technological in Nature; (3) Elimination of Uncertainty/Section 174 Expenses; and (4) Process of Experimentation. The four-part test is one example and other requirements and/or tests may be applied.

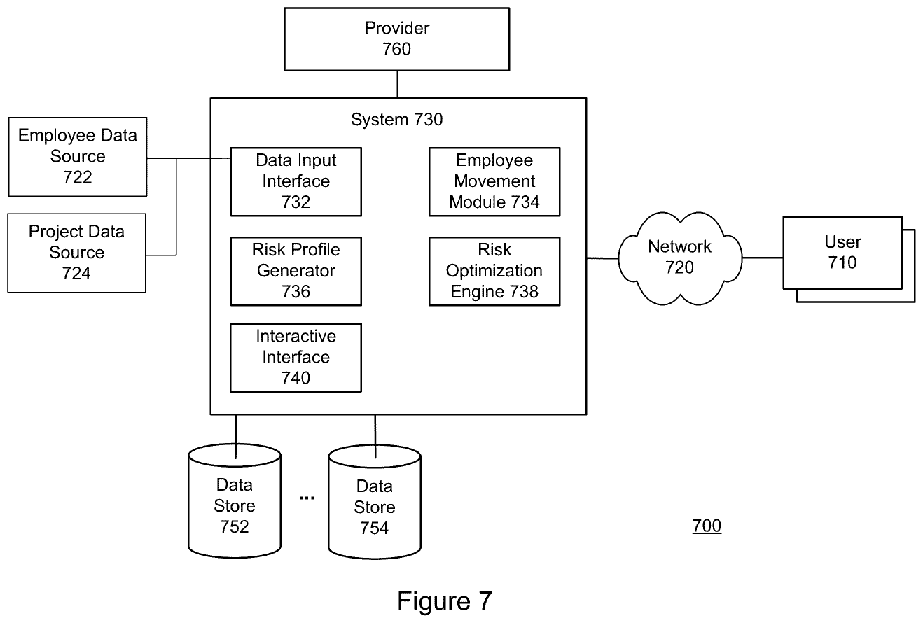

FIG. 7 is an exemplary system diagram, according to an embodiment of the present invention. FIG. 7 illustrates a schematic diagram of a system that implements a research and development tax credit risk assessment and optimization tool, according to an exemplary embodiment. As illustrated in FIG. 7, Network 720 may be communicatively coupled to user devices, represented by 710. Other systems may be supported including other users, teams via various computing devices. Computing devices may include computers, laptops, workstations, kiosks, terminals, tablets, mobile devices, mobile phones, smart devices, etc.

Network 720 communicates with System 730 that provides risk profile and optimization analysis. System 730 may include Data Input Interface 732, Employee Movement Module 734, Risk Profile Generator 736, Risk Optimization Engine 738, and Interactive Interface 740.

Data Input Interface 732 may receive employee data as well as project data from various sources including Employee Data Source 722, Project Data Source 724.

Employee Movement Module 734 provides a comprehensive overview of employee movement from one business component to another and may identify changes in teams, titles, onboarding, offboarding, etc.

Risk Profile Generator 736 depicts changes in various datasets used to calculate R& D tax credits. Variances for a period of time may include: qualified expenses, headcount, title change, activity (ongoing versus new activity), etc.

Risk Optimization Engine 738 provides an analysis of appropriate risk tolerances and reserve based on variances and changes.

Interactive Interface 740 may provide risk assessment and optimization analysis to users.

Others users and integrations may be supported.

The system components are exemplary and illustrative, System 730 may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

System 730 may be communicatively coupled to data storage devices represented by Data stores 752, 754. Data stores 752, 754 may also store and maintain source code, reports, performance data, historical data, etc. The clustering and scoring features described herein may be provided by System 730 and/or a third party provider, represented by 760, where Provider 760 may operate with System 730.

The system 700 of FIG. 7 may be implemented in a variety of ways. Architecture within system 700 may be implemented as hardware components (e.g., module) within one or more network elements. It should also be appreciated that architecture within system 700 may be implemented in computer executable software (e.g., on a tangible, non-transitory computer-readable medium) located within one or more network elements. Module functionality of architecture within system 700 may be located on a single device or distributed across a plurality of devices including one or more centralized servers and one or more mobile units or end user devices. The architecture depicted in system 700 is meant to be exemplary and non-limiting. For example, while connections and relationships between the elements of system 700 is depicted, it should be appreciated that other connections and relationships are possible. The system 700 described below may be used to implement the various methods herein, by way of example. Various elements of the system 700 may be referenced in explaining the exemplary methods described herein.

Network 720 may be a wireless network, a wired network or any combination of wireless network and wired network. Network 720 may further include one, or any number of the exemplary types of networks operating as a stand-alone network or in cooperation with each other. Network 720 may utilize one or more protocols of one or more network elements to which it is communicatively coupled. Network 720 may translate to or from other protocols to one or more protocols of network devices. Although Network 720 may be depicted as one network for simplicity, it should be appreciated that according to one or more embodiments, Network 720 may comprise a plurality of interconnected networks, such as, for example, a service provider network, the Internet, a cellular network, corporate networks, or even home networks, or any of the types of networks mentioned above.

Data may be transmitted and received via Network 720 utilizing a standard networking protocol or a standard telecommunications protocol. For example, data may be transmitted using protocols and systems suitable for transmitting and receiving data. Data may be transmitted and received wirelessly or in some cases may utilize cabled network or telecom connections or other wired network connection.

While FIG. 7 illustrates individual devices or components, it should be appreciated that there may be several of such devices to carry out the various exemplary embodiments. System 730 may communicate using any mobile or computing device, such as a laptop computer, a personal digital assistant, a smartphone, a smartwatch, smart glasses, other wearables or other computing devices capable of sending or receiving network signals. Computing devices may have an application installed that is associated with Entity 230.

System 730 may be communicatively coupled to Data Stores 752, 754 as well as remote storages. These storage components may include any suitable data structure to maintain the information and allow access and retrieval of the information. The storage may be local, remote, or a combination. The storage components may have back-up capability built-in. Communications with the storage components may be over a network, such as Network 720 or communications may involve a direct connection between the various storage components and Provider 760, as depicted in FIG. 7. The storage components may also represent cloud or other network based storage.

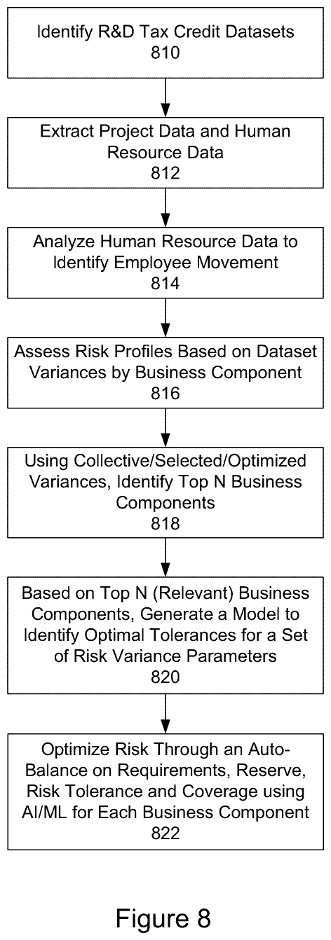

FIG. 8 is an exemplary flowchart, according to an embodiment of the present invention. At step 810, datasets may be identified. At step 812, project data and human resource data may be extracted. At step 814, human resource data may be analyzed to identify employee movement. At step 816, risk profiles based on dataset variances may be assessed by business component. At step 818, using the variances, a top set of business components may be identified. At step 820, based on the top set of business components, generate a model that identifies optimal tolerances may be identified for a set of risk variance parameters. At step 822, risk may be optimized through an auto balancing of the set of risk variance parameters for each business component. While the process of FIG. 8 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 810, datasets may be identified. The datasets may be specific to R&D tax credits. In this example, the datasets may relate to project data and human resource data.

At step 812, project data and human resource data may be extracted. Project data may include activity, issue tracking data, technology development, time sheets, etc.

At step 814, human resource data may be analyzed to identify employee movement. The human resource data may be analyzed to indicate headcount change, size of team, change in titles, etc.

At step 816, risk profiles based on dataset variances may be assessed by business component. Dataset variances may include a year-to-year variance in qualified expenses, headcount, title change, activity (ongoing versus new activity), etc. For example, variances may include increase/decrease in qualified expenses and increase/decrease in headcount value. Other variances may include qualified expenses and headcount variances by percentage. Other variances may include comparisons between ongoing and new activities.

At step 818, using the variances, a top set of business components may be identified. An embodiment of the present invention may focus on a ranked set of business components. The top business components by variance, coverage or other factor may be identified and used to generate a model to identify a set of risk variance parameters to develop optimal tolerances and values. The top set of business components may be considered collectively, based on relevancy and optimized through a learning algorithm for accuracy and performance. For example, a learning algorithm may identify a set of highly relevant business components where low ranking or irrelevant business components may be removed from consideration.

At step 820, based on the top set of business components, an optimization model may be generated that identifies optimal tolerances for a set of risk variance parameters. The optimization model may be generated through an AI/ML algorithm that learns from prior engagements and dynamically determines weights for a set of risk variance parameters comprising: requirements, risk tolerances, reserve and business component coverage

The set of risk variance parameters may include: requirements, risk tolerance, reserve, business component coverage, etc. Risk variance parameters may be modified and varied for additional insights and optimization. Requirements may represent actions needed to comply or qualify for the R&D tax benefit and may include number of interviews, documentation, resources, etc. Risk tolerance may be measured between conservative and aggressive. Reserve may represent tax reserves for uncertain tax positions, consistent with IFRIC 23 that explains how to recognize and measure deferred and current income tax assets and liabilities if there is uncertainty over a tax treatment. Business component coverage may refer to the number of business components analyzed or documented, versus the total number of business components identified as part of the research credit study/investigation.

An embodiment of the present invention may capture top business components by variances which may be based on QRE percentage, headcount percentage, title change percentage, net new development percentage, activity percentage and team change percentage. An embodiment of the present invention may also capture top business components by coverage which may be based on QRE percentage, headcount percentage, title change percentage, net new development percentage, activity percentage and team change percentage.

At step 822, risk may be optimized through an automatic balancing of the set of risk variance parameters for each business component. Optimization may rely on an AI/ML learning algorithm that considers historical data and fine tunes the optimization model by applying weights based on accuracy and performance.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the system software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more of them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A computer-implemented system for implementing a research and development (R&D) risk assessment and optimization tool, the system comprising:
an interface that is configured to access one or more data sources and display risk optimization data;
a memory component that stores and manages data relating to research and development assessment; and
a computer processor coupled to the interface and the memory component, the computer processor further configured to:
identify, via the computer processor, one or more datasets relevant to a research and development tax credit for an entity;
extract, via the interface, data from the one or more data sources, wherein the data comprises project data and human resource data related to one or more business components;
analyze; via the computer processor, the human resource data to identify employee movement data that represents headcount change, title change and team change;
analyze; via the computer processor, the project data to identify variances for the one or more datasets for each business component associated with an entity, wherein the variances relate to the headcount change, the title change, the team change, an activity change and a Qualified Research Expenditures (QRE) change;
assess, via the computer processor, risk profiles based on the variances for the one or more datasets by business component;
identify, via the computer processor, a ranked set of business components based on the variances for the one or more datasets;
based on the ranked set of business components, generate a risk optimization model through a machine learning algorithm that learns from prior engagements and dynamically determines weights for a set of risk variance parameters comprising: requirements, risk tolerances, reserve, and business component coverage;
automatically optimize risk, via the computer processor, based on a combination of the set of risk variance parameters; and
provide, via the interface, an optimized risk and one or more graphics representing the requirements, the risk tolerances, the reserve, and the business component coverage.

2. The system of claim 1, wherein the one or more data sources comprise project management systems, versioning control software repositories, employee rosters and payroll systems.

3. The system of claim 1, wherein the business component comprises potentially qualifying research and development projects.

4. The system of claim 1, wherein the set of risk variance parameters are each adjustable.

5. The system of claim 1, wherein the requirements comprise a number of interviews.

6. The system of claim 1, wherein the reserve comprises funds allocated for R&D tax credit.

7. The system of claim 1, wherein the risk tolerances represents a scale between conversative to aggressive.

8. The system of claim 1, wherein the variances comprise a qualified research expenditure amount for a current time period compared to a variance in year-to-year QRE amount for each business component.

9. The system of claim 1, wherein the variances comprises a current headcount number compared to a variance in year-to-year headcount for each business component.

10. The system of claim 1, wherein the variances comprises a new activity percentage compared to ongoing activity percentage for each business component.

11. A computer-implemented method for implementing a research and development (R&D) risk assessment and optimization tool, the method comprising the steps of:
identifying, via a computer processor, one or more datasets relevant to a research and development tax credit for an entity;
extracting, via an interface, data from one or more data sources, wherein the data comprises project data and human resource data related to one or more business components;
analyzing; via the computer processor, the human resource data to identify employee movement data that represents headcount change, title change and team change;
analyzing; via the computer processor, the project data to identify variances for the one or more datasets for each business component associated with an entity, wherein the variances relate to the headcount change, the title change, the team change, an activity change and a Qualified Research Expenditures (QRE) change;
assessing, via the computer processor, risk profiles based on the variances for the one or more datasets by business component;
identifying, via the computer processor, a ranked set of business components based on the variances for the one or more datasets;
based on the ranked set of business components, generating a risk optimization model through a machine learning algorithm that learns from prior engagements and dynamically determines weights for a set of risk variance parameters comprising: requirements, risk tolerances, reserve, and business component coverage;
automatically optimizing risk, via the computer processor, based on a combination of the set of risk variance parameters; and
providing, via the interface, the optimized risk and one or more graphics representing the requirements, the risk tolerance, the reserve, and the business component coverage.

12. The method of claim 11, wherein the one or more data sources comprise project management systems, versioning control software repositories, employee rosters and payroll systems.

13. The method of claim 11, wherein the business component comprises potentially qualifying research and development projects.

14. The method of claim 11, wherein the set of risk variance parameters are each adjustable.

15. The method of claim 11, wherein the requirements comprise a number of interviews.

16. The method of claim 11, wherein the reserve comprises funds allocated for R&D tax credit.

17. The method of claim 11, wherein the risk tolerances represents a scale between conversative to aggressive.

18. The method of claim 11, wherein the variances comprise a qualified research expenditure amount for a current time period compared to a variance in year-to-year QRE amount for each business component.

19. The method of claim 11, wherein the variances comprises a current headcount number compared to a variance in year-to-year headcount for each business component.

20. The method of claim 11, wherein the variances comprises a new activity percentage compared to ongoing activity percentage for each business component.
